(19) United States
(12) Patent Application Publication
(10) Pub. No.: US 2024/0062674 A1
(43) Pub. Date: Feb. 22, 2024

(54) DATA FEED INTERACTION INCENTIVIZATION SYSTEM USING GAMIFICATION TOOLS

(71) Applicant: Microsoft Technology Licensing, LLC, Redmond, WA (US)

(72) Inventors: Zoran HRANJ, Oslo (NO); Amund TVEIT, Trondheim (NO)

(21) Appl. No.: 17/820,663

(22) Filed: Aug. 18, 2022

(51) Int. Cl. G09B 19/00; G09B 5/02

(52) U.S. Cl. CPC G09B 19/00; G09B 5/02

(57) ABSTRACT

Examples provide a personalized data feed having progress indicators showing progress indicators associated with goal-related action items in the feed to assist users in achieving personalized objectives. A goal-related progress indicator is generated within the personalized data feed indicating a user's progress towards completing the goal. A per-item progress indicator is generated for each uncompleted item indicating additional predicted progress towards achieving the personalized goal if the item is completed by the user. A visual augmentation is provided within the data feed to identify items in the feed which assist the user in achieving the personalized goal, such as documents to read or review. This motivates the user to interact with the item to work towards completing their goal, as well as provides a comparative and/or quantitative measure of potential goal-related benefit to be gained by interacting with various items in the feed.

### BACKGROUND

Data feeds are frequently used across a variety of platforms to present data items to a user. The items in the data feed can be personalized based on preferred topics or other user-selected criteria. However, these data feeds are typically structured such that the user is encouraged to spend as much time as possible interacting with feed items which may have little or no actual benefit to the user. Moreover, it can be time-consuming for a user to manually review every item in the feed while searching for data items in the feed which are actually of interest or benefit to the user. The user may also overlook items which would be beneficial to the user due to the sheer number of items which may be present in the feed. This can be a frustrating and inefficient experience for users.

### SUMMARY

Some examples provide a system and method for a personalized data feed. A visual augmentation is generated within the personalized data feed associated with each goal-related item of a plurality of items. The personalized data feed is presented via a user interface. The goal-related item is associated with a personalized goal of the user. A goal completion metric value is calculated which indicates current overall progress of the user goal. The value is calculated using interaction data of the user, such as the number of completed goal-related items and the number of incomplete goal-related items. A progress indicator is generated within the personalized data feed which represents the calculated goal completion metric value indicating the current overall progress of the user goal.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for providing a personalized data feed having progress indicators representing progress of a user towards completing a personalized goal of the user.

FIG. 2 is an exemplary block diagram illustrating an interactive feed manager for generating progress indicators for personalized user goals and per-item progress indicators.

FIG. 3 is an exemplary block diagram illustrating a database storing data associated with generating a personalized data feed with visual augmentation and progress indicators.

FIG. 4 is an exemplary block diagram illustrating a personalized data feed with visual augmentation and progress indicators.

FIG. 5 is an exemplary flow chart illustrating operation of the computing device to generate personalized data feed items with visual augmentation and progress indicators.

FIG. 6 is an exemplary flow chart illustrating operation of the computing device to display per-item progress indicators when a user interacts with a goal-related item in the personalized data feed.

FIG. 7 is an exemplary flow chart illustrating operation of the computing device to prioritize goal-related items in a personalized data feed.

FIG. 8 is an exemplary screenshot illustrating a personalized data feed having goal-related items.

FIG. 9 is an exemplary graph illustrating goal-related metrics used to provide progress indicators.

FIG. 10 is a block diagram of an example computing device for implementing aspects disclosed herein and is designated as computing device.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Users are shown a plethora of content on multiple platforms on a daily basis, and it is often difficult for them to judge whether time should be invested into going through some or any of those items. From a platform point of view, it is desirable to maximize interaction with the content. User interaction refers to a user interacting with an element or content in the feed, such as, but not limited to, a user clicking on any item in the feed and/or scrolling the feed. The goal of the platform may be to engage the user in a way that fulfils them and/or in a way that makes them leave the session with a sense of accomplishment. For a given data feed to be useful, it may provide a utility to the user that serves a purpose for the user. This purpose can be anything from psychological satisfaction, education, recommending content likely to be desirable to the user and/or assisting the user in achieving a goal. In this manner, a data feed can also provide data intended to help users improve personally and/or professionally. However, when platforms attempt to maximize interactions in the feed, it can sometimes be a detriment of the user, making them feel like they have wasted their time at the end of a session.

Referring to the figures, examples of the disclosure enable a personalized data feed having visual augmentation of goal-related items and progress indicators associated with personalized user goals. In some examples, the system generates a visual augmentation associated with goal-related items in the personalized data feed. The visual augmentation enables a user to identify items quickly and efficiently in the feed that will assist the user in achieving a personalized goal while increasing user engagement with a platform in a productive way.

In other aspects of the examples, the system calculate a goal completion metric value indicating current overall progress of the user toward completing the user's goal using interaction data of the user. The term “current” refers to real-time relative to the present user interaction. In this example, the user's current overall progress is the progress of the user toward achieving the goal at the time the metric value is calculated. The metric value quantifies a level of progress by the user towards reaching the user-defined goal. The metric value is calculated using a metric, such as a key performance indicator (PKI), selected by the user. This enables the user to customize goal-related metrics while obtaining dynamic metric values measuring progress towards reaching a goal. This encourages and motivates the user to continue working towards the goal.

In still other examples, the system generate a goal-related progress indicator within the personalized data feed representing the calculated goal completion metric value. The indicator provides a graphic icon, progress bar or other graphic indicator representing the metric value. This enables the user to obtain an accurate and efficient status update regarding the user's progress toward meeting a goal.

Other aspects provide per-item progress indicators providing an indication of how much closer the user will be to completing their goal if they consume the recommended item. With this approach, the user is able to quickly gauge the benefit of consuming any content in accordance with the user's chose parameters for assessing the content.

The interactive feed manager executing on a computing device utilizes goal-related items and interactive data to prioritize items in a feed and generate progress indicators reflecting progress of a user towards completing a goal by consuming goal-related content identified in the feed. The computing device operates in an unconventional manner by providing visual augmentation of goal-related items and dynamic progress indictors based on personalized goals. In this manner, the computing device operates in an unconventional manner by providing a personalized data feed with goal-related progress indicators, thereby reducing system processor and network usage consumed while serving unwanted or un-useful content to the user, thereby improving the functioning of the underlying computing device.

The interactive feed manager in other examples further improves user-interaction with the computer interface by indicating in the user interface content in the feed most likely to be beneficial to the user's customized goals to reduce user time spent reviewing less relevant content for more efficient provision of desired information to the user. The personalized data feed further enables increased user engagement with the personalized data feed platform while ensuring the user spends their time in a productive manner.

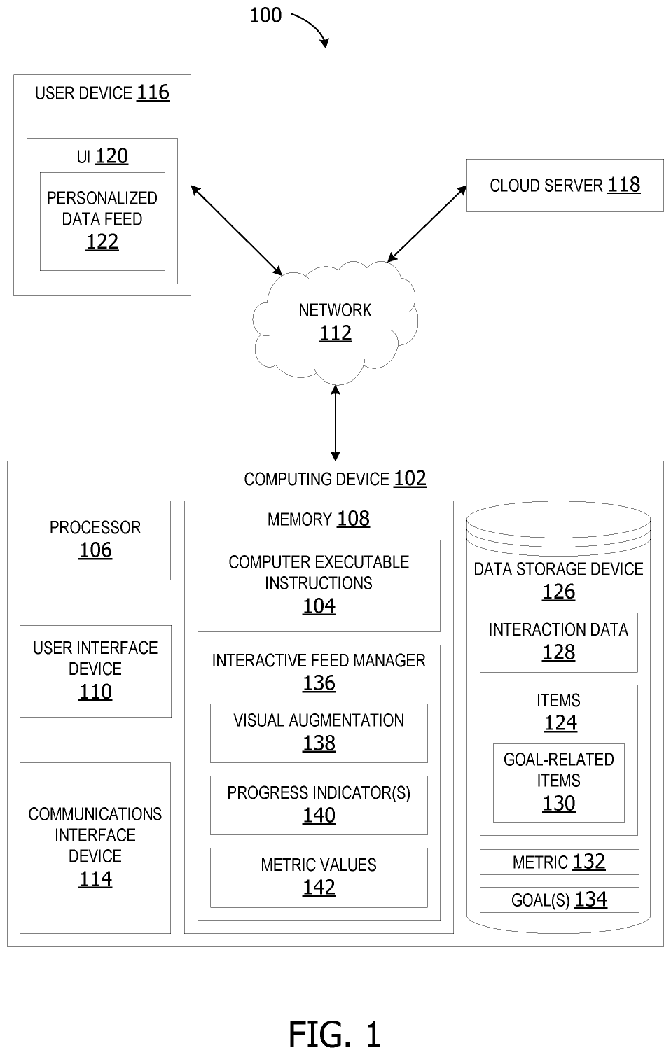

Referring again to FIG. 1, an exemplary block diagram illustrates a system 100 for providing a personalized data feed having progress indicators representing progress of a user towards completing a personalized goal of the user. The personalized data feed 122 is a personalized data feed including content from one or more sources, such as, but not limited to, search results, content feed, video feed, messaging inbox, etc. A feed can include a news feed, data feed, video content feed, messaging feed, work-related data feed, or any other type of data feed.

In the example of FIG. 1, the computing device 102 represents any device executing computer-executable instructions 104 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has a processor 106 and a memory 108. The computing device 102 in other examples includes a user interface device 110.

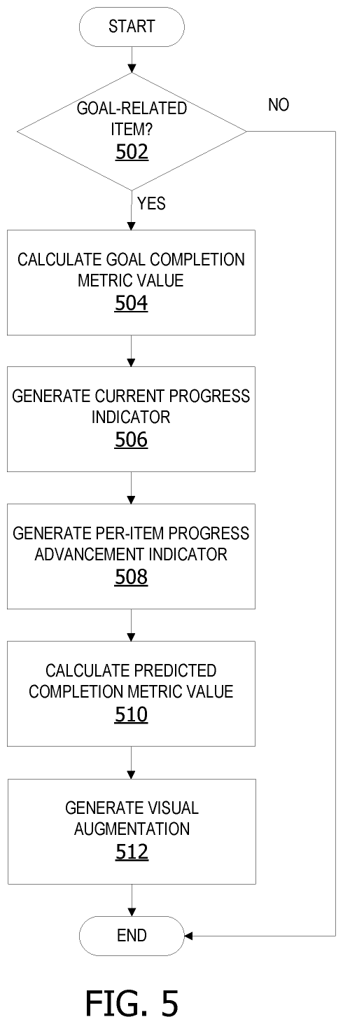

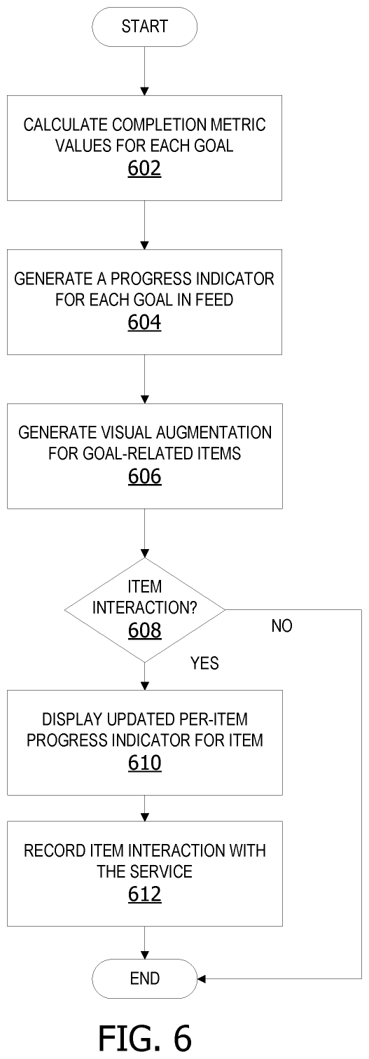

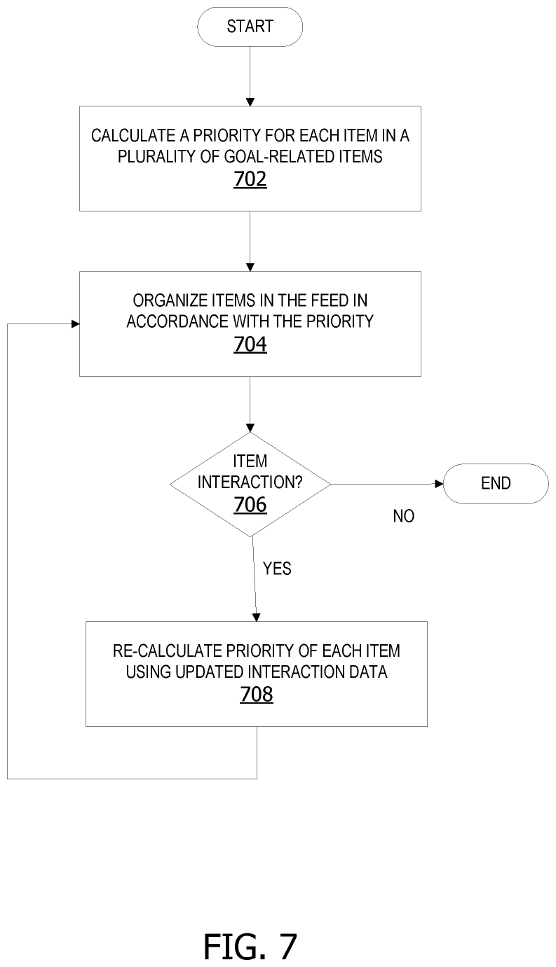

The processor 106 includes any quantity of processing units and is programmed to execute the computer-executable instructions 104. The computer-executable instructions 104 is performed by the processor 106, performed by multiple processors within the computing device 102 or performed by a processor external to the computing device 102. In some examples, the processor 106 is programmed to execute instructions such as those illustrated in the figures, such as FIG. 5, FIG. 6, and FIG. 7).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown).

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

In some examples, the user interface device is a screen on a display device. In other examples, the user interface is an interface within a virtual reality or augmented reality. A virtual reality user interface may be generated via a virtual reality headset. An augmented reality user interface may be generated via an augmented reality headset.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device. In this example, the user device includes a user interface (UI) 120 for displaying a personalized data feed 122 containing a plurality of data feed items 124 to a user.

The cloud server 118 is a logical server providing services to the computing device 102 or other clients, such as, but not limited to, the user device 120. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The system 100 can optionally include a data storage device 126 for storing data, such as, but not limited to interaction data 128, goal-related items 130, user-selected metric 132 and/or personalized goal(s) 134. The interaction data 128 is data associated with user interaction with goal-related items 130. The interaction data can include information related to an amount of time a user interacts with an item, such as the number of minutes a user spends reading a document, for example. The interaction data in other examples includes the number of items recommended for a particular goal which is completed and/or the number of items recommended for a particular goal which is uncompleted.

The goal-related items 130 are items from a plurality of items which are relevant to a personalized goal of the user. The plurality of items includes any type of content and/or links to content which can be presented to a user via a data feed. In some examples, the plurality of items includes content and/or links to content such as, documents, videos, emails, direct messages, images, tasks, educational materials, etc. The documents can include educational documents, news articles, reports, instructional documents, project-related documents, documents created by members of a team, documents authored by a specific person, documents relating to a topic or subject-matter, or any other type of documents.

For example, if the user's personalized goal is to read all reports associated with a particular project at the user's workplace, each report associated with the project is an item in the goal-related items 130. If there are four reports, then the set of goal-related items includes four items. If a user reads two of those reports, the user is half-way towards completing the goal, for example.

In another example, if the user's goal is to stay up-to-date on the subject of machine learning, the goal-related items in the interactive feed of the user may include a five articles associated with new developments in the field of machine learning. The five articles can include news articles, technical journal articles, educational articles and/or other types of documents associated with the subject of machine learning. If the user reads one of the articles, the metric value for goal progress is twenty percent or one-fifth. When the user completes two out of the five articles, the user is forty percent or two-fifths of the way towards completing the goal of staying current on the topic of machine learning. Other goal-related items in these examples can include videos, images, email messages, inter-office memoranda, promotional materials, or any other types of documents or links to documents related to the user-defined goal.

The metric 132 is a user-selected metric or a default metric for quantifying the user's progress towards completing the goal. The metric can include a percentage metric, a ratio metric, a time-based metric, or any other user-configurable metric associated with a user-selected goal. The goal(s) 134 include a personalized goal. The goal, in some examples, is selected from a predefined list of goals. In other examples, the user creates or configures the goal.

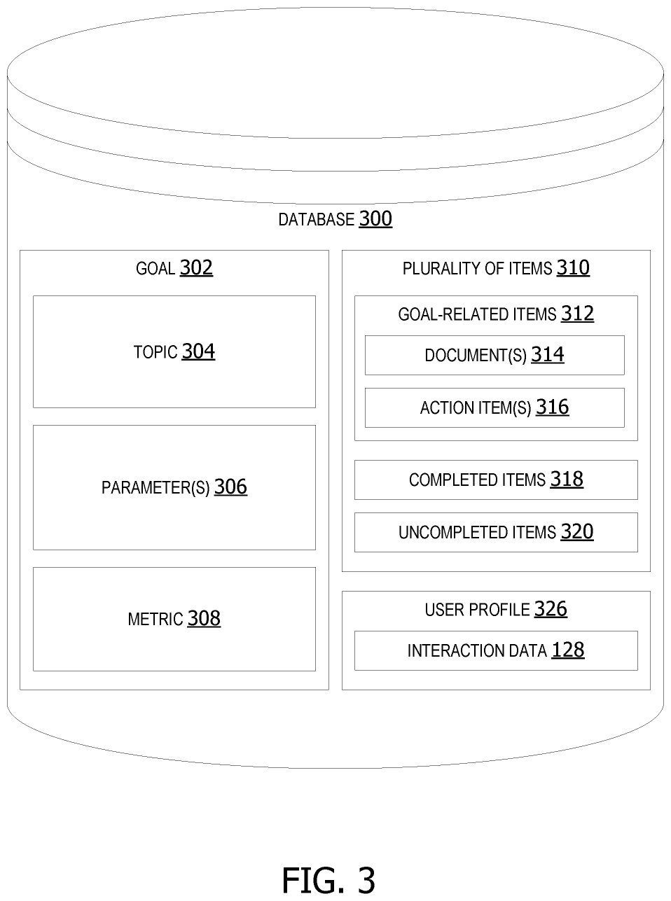

The data storage device 126 can include one or more different types of data storage devices, such as, for example, one or more rotating disks drives, one or more solid state drives (SSDs), and/or any other type of data storage device. The data storage device 126 in some non-limiting examples includes a redundant array of independent disks (RAID) array. In other examples, the data storage device 126 includes a database, such as, but not limited to, the database 300 in FIG. 3.

The data storage device 126 in this example is included within the computing device 102, attached to the computing device, plugged into the computing device, or otherwise associated with the computing device 102. In other examples, the data storage device 126 includes a remote data storage accessed by the computing device via the network 112, such as a remote data storage device, a data storage in a remote data center, or a cloud storage.

The memory 108 in some examples stores one or more computer-executable components, such as, but not limited to, an interactive feed manager. The interactive feed manager 136 component, when executed by the processor 106 of the computing device 102, generates a visual augmentation associated with a goal-related item in a plurality of items within the interactive, personalized data feed presented to a user via a user interface device. The goal-related item is associated with a goal of the user. The interactive feed manager 136 calculates goal completion metric value(s) 142 indicating current overall progress of the user toward completing each of the goal(s) 134 using interaction data of the user. The interaction data 128, in this example, includes a number of completed goal-related items in a plurality of goal-related items completed and/or a number of incomplete goal-related items in the plurality of goal-related items. The interactive feed manager 136 generates progress indicator(s) 140 in the user interface, such as goal-related progress indicators and/or per-item progress indicators within the personalized data feed. The goal-related progress indicator represents the calculated goal completion metric value indicating the current overall progress of the user toward completing the goal.

The progress indicator is a visual indicator in the user interface representing a progress of the user towards completing a goal. The progress indicator in some examples is displayed adjacent to the goal-related item in the personalized data feed. In other examples, the progress indicator is displayed in a pop-up window when a user interacts with the goal-related item. In still other examples, the progress indicator is displayed above the goal-related item or goal-related item(s). For example, the progress indicator can be displayed at the top of the data feed or at the top of a set of goal-related items grouped together in the data feed.

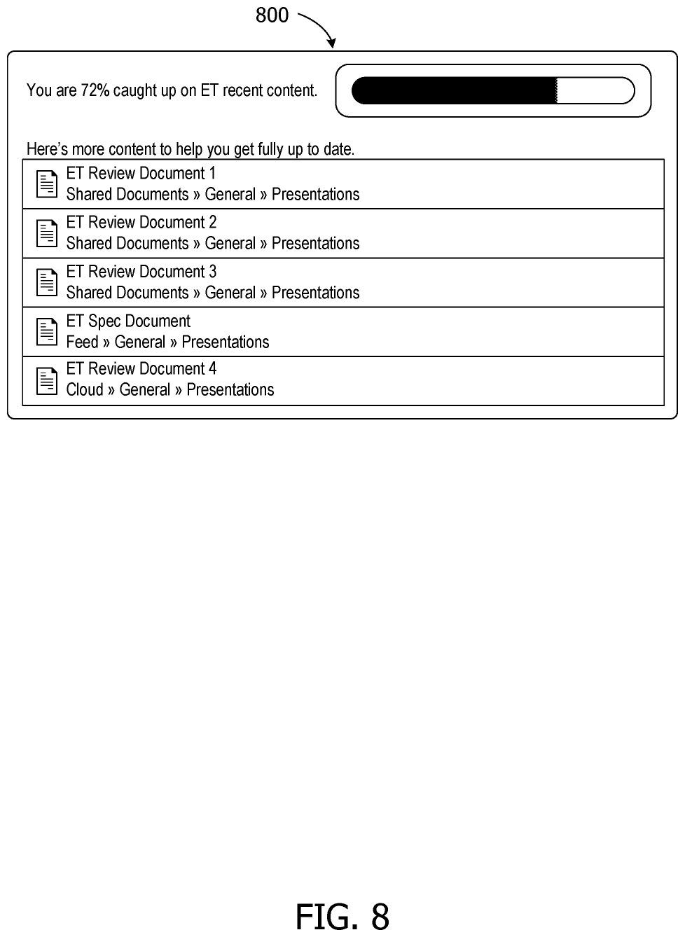

The progress indicator can be implemented as any type of visual indicator, such as an alphanumeric value, a graphic, an icon, a symbol, or any other visual indicator. In some examples, the progress indicator is a percentage value. In other examples, the progress indicator is a progress bar, as is shown in FIG. 8 below. In still other examples, the progress indicator is a graph, pie chart, or other graphic representing the metric value associated with a given goal and/or a given goal-related item.

In other examples, the interactive feed manager 136 calculates per-item completion metric value(s) indicating a predicted completion contribution associated with user completion of the goal-related item. The interactive feed manager 136 in other examples, generates a per-item progress indicator associated with the goal-related item within the personalized data feed 122 representing the per-item predicted completion metric value. The per-item progress indicator provides a predicted level of additional user progress towards completion of the goal achievable by user completion of the goal-related item.

In still other examples, the interactive feed manager 136 generates a visual augmentation 138 for each goal-related item displayed within the personalized data feed 122. The visual augmentation 138 refers to augmenting an appearance of an item in the personalized data feed that is associated with a goal such that the item is distinguishable from other items in the feed which are unrelated to the goal. The visual augmentation in some examples includes an overlay of color, underscoring, offset, font change, tagging, labeling, or any other visual augmentation of an item in the data feed. An overlay of color can include highlighting the item with a line of color under the item descriptor or on top of the item descriptor. An offset can include an indentation before the item or any other offset which sets the item apart from other items in the feed unrelated to the goal. A font change can include changing font size, a different font style and/or altering font colors of goal-related items. Tagging or labeling goal-related items refers to adding a symbol, alphanumeric, icon or other identifier augmenting the item in the data feed.

The interactive feed manager 136 uses per-item completion metric values for the goal-related items to generate a plurality of per-item progress indicators within the personalized data feed 122. A per-item progress indicator is associated with each goal-related item within the personalized data feed, and wherein each per-item progress indicator provides a representation of the per-item completion metric value for a corresponding goal-related item in the personalized data feed. This provides the user with a quick and easy to interpret indicator identifying goal-related items and per-item contributions toward meeting the goal. In this manner, user interaction with the interface is improved while reducing system resource usage by improving overall data feed interaction efficiency

In some examples, the interactive feed manager 136 presents the user with personalized objectives and key results (OKRs) that the user can personalize to set a goal. With insights into topics and people that interest a particular user, the system is able to present the user with personalized OKRs that they can set for themselves. The personalized objectives are topics or achievements selected by the user. The goals are used to identify goal-related items from the plurality of items in the feed.

In an example, a user may want to stay up-to-date on anything related to sustainable engineering. Once such objective is locked in by the user explicitly choosing it, different measurements of completion may be used. In one example, the metric is the percentage of documents read on the topic of sustainable engineering out of all that are available to the user.

Another example, this time of an implicit OKR, is the ratio of documents read related to a project a person is working on or a team to which they belong. The interactive feed manager attaches a metric to each item in the feed to encourage the user to interact with the content relevant to a goal of the user. For example, if the user wants to stay current on a team's documents, the interactive feed manager provides metrics indicating how close the user is to being 100% current based on the documents the user has already read and the documents which the user has not yet read. In another example, an alternative metric is the number of minutes to read until completion. Most documents have reading time estimates, so those estimates are aggregated to display a metric to the user indicating where they stand according to their personal goal, such as an OKR.

With this established, next time a document within a specific topic associated with the goal is displayed to the user, it is enriched with information related to the user's personal objective: showing the completion rate in the relevant topic. For example, the user may be 73% complete. The system also optionally provides the completion rate if the document is read. For example, if the document is read, the overall progress toward completion increases from 73% to 77%. This visual cue is a very measurable benefit to the user of consuming particular content. Additional existing ranking techniques can be used to bring forth the most beneficial content for any user, such as, the content that is the most popular, most cited, most different, etc.

In other examples, the interactive feed manager 136 includes other content types and people interactions. For example, some users may choose to track the percentage of team code reviews they do and be reminded of new code or pull requests, that needs to be reviewed.

For example, the progress indicator can indicate that a user has read 57% of the user's team documents produced in the last two months. In another example, the metric values indicate the user has 235 minutes of reading to fully catch up on a project titled “Greenland”. In yet another example, the progress indicator indicates the user is 100% caught up on a given topic. In still other examples, the interactive feed manager 136 provides a progress indicator indicating that the user has reviewed 90% of all the user's team pull requests. In other examples, the interactive feed manager 136 can also recommend similar, related topics for a given user to follow. For example, if the user selects a goal of staying up to date on a machine learning topic, the interactive feed manager 136 can also recommend the user set of goal of reading articles on deep learning as well. The user can accept or reject the recommended goal topics.

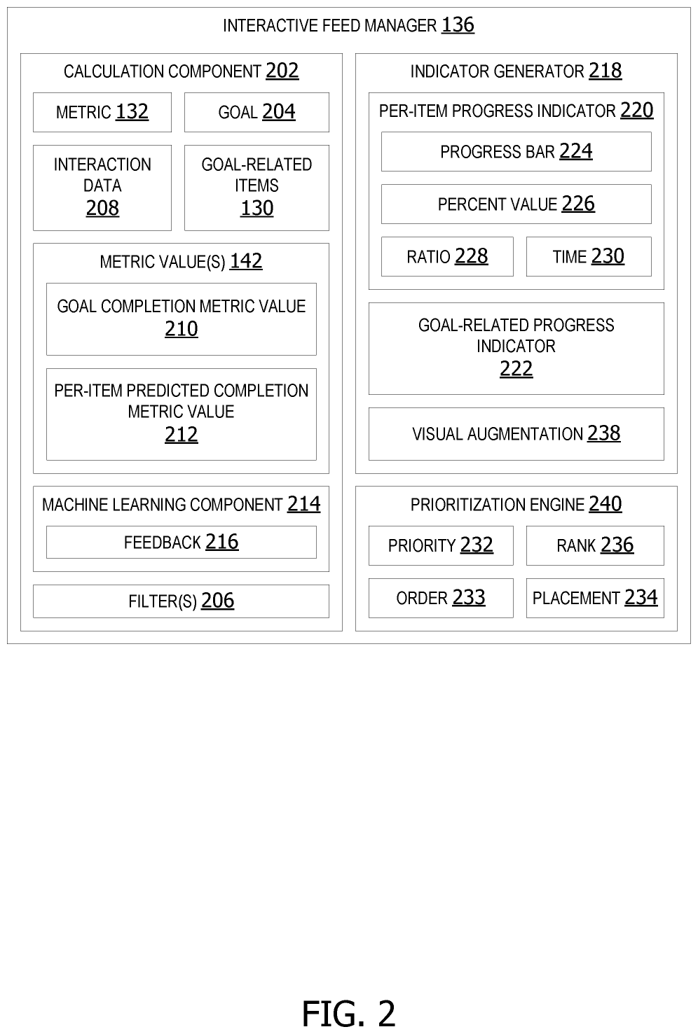

FIG. 2 is an exemplary block diagram illustrating an interactive feed manager 136 for generating progress indicators for personalized user goals and per-item progress indicators. In some examples, the interactive feed manager 136 includes a calculation component 202 that applies a user-selected metric 132 for a given user-defined goal 204. The interactive feed manager 136 applies one or more filter(s) 206 to identify goal-related items 130 which are recommended or otherwise identified as relevant to accomplishing the user's goal 204.

The interactive feed manager 136 uses interaction data 208 and the metric 132 to generate metric value(s) 142. The metric value(s) 142 can include a goal completion metric value 210 measuring a user's progress towards achieving the goal 204 and/or per-item predicted completion metric value 212. The per-item predicted completion metric value 212 indicates how much user completion of a given item would contribute towards completion of the goal 204. Thus, if there are four articles in the goal-related items and each article is roughly equal length and estimated value to achieving the goal 204, a user reading one of the articles would be 25% closer to reaching the goal. If the user reads two of the four articles, the user would be predicted to be 50% closer to reaching the goal of being caught up on reading all articles on a given topic. In this example, the per-item predicted completion metric value 212 for each of the four articles would be 25% or one-fourth.

In some examples, the interactive feed manager 136 includes a machine learning component 214. The machine learning component 214 optionally includes pattern recognition, modeling, or other machine learning algorithms to analyze goal-related data, such as interaction data and metric value(s) 142 to filter goal-related items, prioritize items, and/or increase user interaction with goal-related items. In some examples, the machine learning component 214 uses the data stored in one or more databases with real-time user interaction data 208 and/or user feedback 216 to learn how to optimize filtering and presentation of goal-related items in the personalized data feed.

The system, in some examples, updates the machine learning component using the interaction data and the user feedback associated with goal-related items for a given user-selected goal. The machine learning component improves selection of goal-related items from a plurality of items to assist the user in achieving the goal while increasing user interaction with items in the personalized data feed.

In other examples, the interactive feed manager 136 includes an indicator generator 218 which generates a per-item progress indicator 220 for each goal-related item and/or a goal-related progress indicator 222 for each goal. A progress indicator can include, for example, a progress bar 224 representing a percentage value 226, a ratio 228, an amount of time 230 or any other metric value.

In other examples, the interactive feed manager 136 applies a visual augmentation 238 to goal-related items in the personalized data feed. In some examples, the visual augmentation 238 can include highlighting the item, identifying the item with a distinct font size, identifying the item with a distinct font type, a distinct font color used on the item, a box around the item, underling the item, placing a marker or icon next to the item, or any other visual augmentation to make goal-related items in the feed more prominent or noticeable than items which are not related to a user goal. A distinct font style refers to a different font. For example, if items in the data feed are in Times New Roman, the goal-related item may be displayed in Courier font. In other examples, the goal-related item may be displayed with italicized font, underlined font, all-caps, larger font, smaller font, or any other font alteration which distinguishes the item from other items which are unrelated to the goal.

In some examples, each goal-related item in the feed is presented in the user interface with a different visual augmentation. In other examples, all items in the personalized data feed associated with the same goal are presented with the same visual augmentation. Thus, if there are items in the data feed associated with two different user-defined goals, all the goal-related items associated with the first goal are presented with a first visual augmentation and all the goal-related items associated with the second goal are presented with a second visual augmentation, such that all the goal-related items for the first goal have the same visual augmentation and all the goal-related items for the second goal have the same, second visual augmentation. For example, items for a first goal can be presented in red font while items for a second goal are presented in blue font. In this manner, the user can quickly identify all the items having the red font visual augmentation as being related to the first goal, items in blue font are associated with the second goal, and items in the traditional black font are items in the feed unrelated to both the first and second goals.

In still other examples, the interactive feed manager 136 includes a prioritization engine 240. The prioritization engine 240 calculates a priority 232 value for each item in the feed. Goal-related items have a higher priority than items which are not goal related. Moreover, the prioritization engine 240 assigns a higher priority to goal-related items which are most likely to meet the user's goals and items which the user's is predicted to find interaction beneficial or otherwise worthwhile. The prioritization engine 240 in other examples assigns a rank 236 to each item based on how closely a given item aligns with a goal of the user.

The interactive feed manager 136 uses the priority 232 and/or rank 236 of each item to determine an order 233 in which items are arranged in the feed. For example, all items associated with a given goal can be grouped together in the feed. In other examples, the priority and/or rank for each item is used to determine placement 234 of items in the feed. For example, higher ranked items are placed at the top of the feed while lower ranking or lower priority documents are placed lower down in the feed.

FIG. 3 is an exemplary block diagram illustrating a database 300 storing data associated with generating a personalized data feed with visual augmentation and progress indicators. In some examples, the database 300 includes data associated with user goal(s) 302. The goal(s) 302 data optionally includes a user-selected topic 304, parameter(s) 306 and/or a metric 308 for measuring progress towards achieving the goal. The topic 304 is a subject or topic area for items. The topic 304 can include a subject area, such as machine learning or virtual machines. The parameter(s) 306 are guidelines, rules, or criteria for selecting goal-related items. For example, a user may select parameter(s) specifying that only reports generated within a given time-frame should be included as a goal-related item. In other examples, the parameter(s) may specify that only documents of certain size or page length should be included. In still other examples, the parameters may specify certain authors whose documents should be included or excluded from the goal-related items, etc.

In other examples, the database 300 includes data associated with a plurality of items 310 for the data feed, including one or more goal-related items 312. The goal-related items 312 can include document(s) 314 and/or action item(s) 316. An action item is a task or other action to be performed. An action item can include, for example, but without limitation, a reminder to reply to a message, a request to review a document, etc. The item data can also include data describing completed items 318 and/or uncompleted items 320. Completed items are items which the user has completed. For example, if the item is a document, the item is complete when the user has read or reviewed the document.

Interaction data 128 is data associated with which items the user has completed. The interaction data 128 can include time spent reading documents, number of items completed, percentage of recommended goal-related items completed, number of items which are uncompleted or partially completed, items the user identifies as un-useful, etc. The interaction data 128 is optionally stored in a user profile 326 for the user.

In some examples, an item is completed, for example, when a document is read, or another goal-related task is performed. The system updates progress when an item is complete. In other examples, the system performs partial progress updates where the user did not complete the item fully. Status per item is maintained. The user can return to partially completed items later and finish it, at which time, another status update is performed to indicate the partially completed item has been completed.

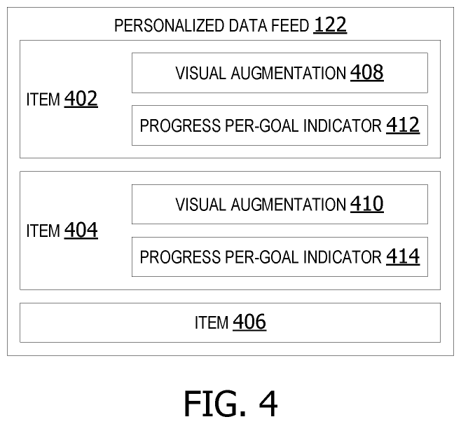

FIG. 4 is an exemplary block diagram illustrating a personalized data feed 122 with visual augmentation and progress indicators. In this example, the personalized data feed 122 includes three items. However, the examples are not limited to three items. In other examples, the personalized data feed can include less than three items or more than three items. In some examples, the data feed can include dozens or hundreds of items.

The item 402 is presented with a visual augmentation 408 to make the item more distinct and increase visibility to the user. The visual augmentation 408 indicates the item 402 is associated with a user's goal. The item 402 in this example includes a per-goal progress indicator. The progress indicator 412 indicates the user's progress towards completing the goal.

The item 404 in this example also includes a visual augmentation 410. If the item 402 and the item 404 are goal-related items for the same goal, the item visual augmentation 410 is the same visual augmentation as the visual augmentation 408. In other words, items for the same goal have the same visual augmentation. If the visual augmentation 408 is yellow highlighting, then the item 404 is also highlighted in yellow.

In other examples, item 404 is an item associated with a different goal than the item 402. In these examples, the visual augmentation 408 is optionally different than the visual augmentation 410 enabling the user to quickly identify items associated with different goals. Thus, if the visual augmentation 408 is yellow highlighting, the visual augmentation 410 can optionally be a different color, such as green or orange highlighting.

In some examples, when the cursor hovers over the item or the user otherwise interacts with the item 404, a per-item progress indicator 414 is displayed. In other examples, the per-item progress indicator is always displayed with the item descriptor or title regardless of whether the user interacts with the item or not. The per-item progress indicator represents a contribution of the item towards achieving the goal. In this example, item 406 is not a goal-related item and does not include a visual augmentation.

FIG. 5 is an exemplary flow chart illustrating operation of the computing device to generate personalized data feed items with visual augmentation and progress indicators. The process shown in FIG. 5 is performed by an interactive feed manager, executing on a computing device, such as the computing device 102 in FIG. 1 and/or the user device 116 in FIG. 1.

A determination is made whether a goal-related item which has not yet been completed remains at 502. If yes, goal completion metric value is calculated at 504. The metric value is calculated based on a user-selected metric, such as a percentage value, ratio, etc. The goal completion metric value indicates how close the user is to completing the goal based on the goal-related items the user has completed. A per-goal progress indicator 506 is generated for the personalized user goal at 506. A per-item progress indicator is generated representing the metric value at 508. The progress indictor is an icon, text or graphic representing the goal completion metric value. In some examples, the progress indicator is a progress bar. If yes, a per-item predicted completion metric value is calculated for the item at 510. The per-item progress indicator is an icon, text, graphic or other representation of the metric value, such as, but not limited to, a progress bar. A visual augmentation is generated for each goal-related item in a plurality of items associated with a personalized user goal at 512. The visual augmentation is a graphic icon, font style, font color, highlighting or other augmentation distinguishing goal-related items in the feed from items which are unrelated to the personalized user goal. The process terminates thereafter.

While the operations illustrated in FIG. 5 are performed by a computing device, aspects of the disclosure contemplate performance of the operations by other entities. In a non-limiting example, a cloud service on a cloud server performs one or more of the operations. The cloud server is a cloud server such as the cloud server 118 in FIG. 1. In another example, one or more computer-readable storage media storing computer-readable instructions may execute to cause at least one processor to implement the operations illustrated in FIG. 5.

FIG. 6 is an exemplary flow chart illustrating operation of the computing device to prioritize goal-related items in a personalized data feed. The process shown in FIG. 6 is performed by an interactive feed manager, executing on a computing device, such as the computing device 102 in FIG. 1 and/or the user device 116 in FIG. 1.

Completion metric values are calculated for each goal at 602. A progress indicator is generated for each goal at 604. A visual augmentation for goal-related items in a personalized data feed is generated at 606. The visual augmentation distinguishes the goal-related item from other items unrelated to the goal. A determination is made whether a user interacts with an item in the feed at 608. If yes, a per-item progress indicator is displayed for the item at 610. In some examples, the user interacts with the item by hovering a cursor over the item or clicking on the item. Item interaction with the service is recorded at 612. The process terminates thereafter.

While the operations illustrated in FIG. 6 are performed by a computing device, aspects of the disclosure contemplate performance of the operations by other entities. In a non-limiting example, a cloud service on a cloud server performs one or more of the operations. The cloud server is a cloud server such as the cloud server 118 in FIG. 1. In another example, one or more computer-readable storage media storing computer-readable instructions may execute to cause at least one processor to implement the operations illustrated in FIG. 6.

FIG. 7 is an exemplary screenshot illustrating a personalized data feed having goal-related items. The process shown in FIG. 7 is performed by an interactive feed manager, executing on a computing device, such as the computing device 102 in FIG. 1 and/or the user device 116 in FIG. 1.

A priority is calculated for each item in a plurality of goal-related items at 702. The items in the feed are organized in accordance with the priority for each item at 704. A determination is made whether a user interaction with the item occurs at 706. If yes, the priority of each remaining item in the set of goal-related items is recalculated using updated interaction data at 708. The updated interaction data is data indicating one of the items is completed or partially completed. The process terminates thereafter.

While the operations illustrated in FIG. 7 are performed by a computing device, aspects of the disclosure contemplate performance of the operations by other entities. In a non-limiting example, a cloud service on a cloud server performs one or more of the operations. The cloud server is a cloud server such as the cloud server 118 in FIG. 1. In another example, one or more computer-readable storage media storing computer-readable instructions may execute to cause at least one processor to implement the operations illustrated in FIG. 7.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

FIG. 8 is an exemplary screenshot 800 illustrating a personalized data feed having goal-related items. In this example, a set of goal-related items are displayed in a personalized data feed with a goal-related progress indicator showing that the user is 72% of the way towards completing the goal. The goal-related progress indicator is a unique progress indictor for each user goal. In other words, if there are two different user goals for a given data feed, there are two different goal-related progress indicators, one unique goal-related progress indicator for each goal. The progress indicator indicates the user's level of progress for each goal, which can be the same level of progress or different levels of progress. For example, a user may have completed two different goals to a fifty percent progress. In such case, even though both progress indicators represent the same fifty percent progress value, each goal is represented by its own unique goal-related progress indicator. Likewise, if one goal is fifty percent complete and the other goal is eighty percent complete, one progress indictor represents the fifty percent value, and the other progress indicator represents the eighty percent metric value. Thus, in this example, two different progress indictors are present in the personalized data feed representing the metric value for each different user goal.

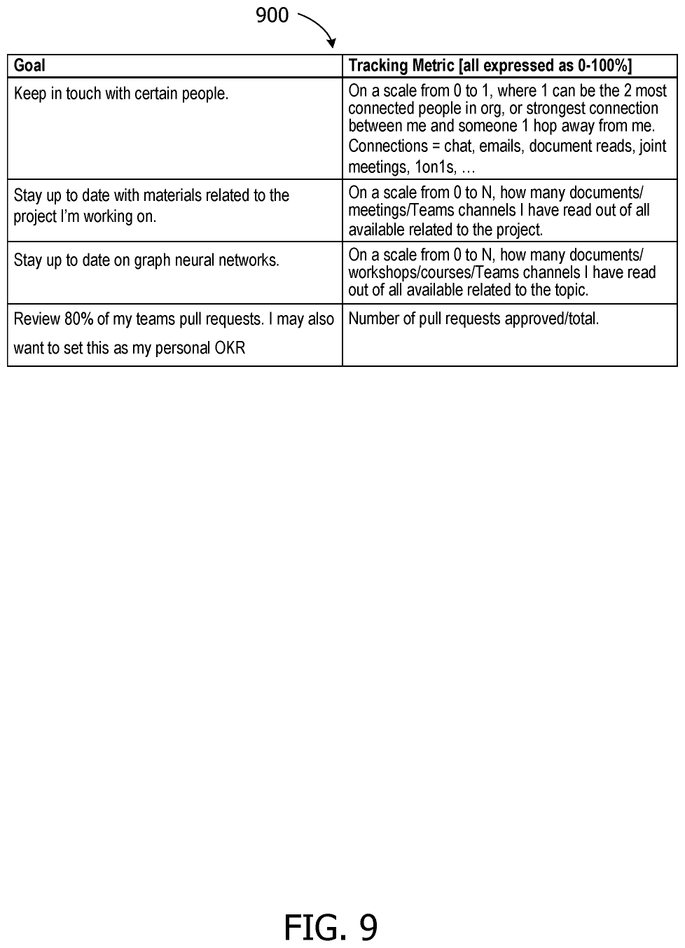

FIG. 9 is an exemplary table 900 illustrating goal-related metrics used to provide progress indicators. The table 900 includes exemplary metrics which can be used to track progress towards achieving various personalized user goals.

In some examples, the system permits users to define goals or focus areas which they want to keep nourishing. In this example, a goal can be defined to remind the user to keep in touch with certain people. Another goal can include “I want to stay up to date with materials related to the project I'm working on.” In another example, the goal is to stay up to date on graph neural networks. Yet another example goal states “I want to set a goal to review 80% of my teams pull requests. I may also want to set this as my personal OKR.”

The system helps a user keep up with these goals by recommending people and content relevant to those goals, as well as recommending actions to best achieve those goals. For example, an item in the feed can state “Your team member David wrote Preliminary Summary of the New Recommendation System and asked for feedback. Could you help David out?” In this example, the system can recommend user reading a document to nurture a personal relationship.

To further boost the effectiveness of the feed, these goals could be gamified in different ways. Different metrics can be used for different goals, some examples are in the table 900. The user is provided with actionable and measurable actions, such as read file, reply to email, comment thread, like document, etc. The goal-related action items help the user move the towards the desired goal.

### Additional Examples

In some examples, the system enriches content snippets in a personalized data feed or other platform UI with personalized gamification elements. A user sets a personal KPI. The interactive feed manager tracks it automatically using the personalized KPI and shows the user what to review/read to stay on track of that personal KPI.

The system, in some examples, tracks everything authored by a certain individual; tracks meetings attended; tracks meetings missed; and tracks materials associated with the goal, such as reviewed documents, generated documents and other work product contributed to a specific project. When specific content relevant to a personal goal is identified by the interactive feed manager ML model, the item in the feed is augmented visually to indicate it is content related to achieving the goal.

In some examples, the visual augmentation is a graphic added over/on top of the feed item representation. For example, the item can be highlight, printed in larger font than other feed items, etc. In an example scenario, when a user hovers over the visual augmentation feature, it pops up a window with information about the related KPI, shows a progress indicator, and other materials that can help also reach the goal for that KPI.

The feed, in other examples, is organized in a priority of items that are related to one or more KPIs. Items related to the same goal are grouped together under related KPI and prioritized. Items may be prioritized based on which metric indicates a higher priority. An item may be reduced in priority if it is stale. An item in the feed is stale if the user has not interacted with the item after a threshold time period and/or the last interaction of the user with the item is outside a threshold time period. In this manner, the system increases engagement with the items in the feed by communicating to the user the importance of the item in the feed to the user's personal goal.

In some examples, the interactive feed manager managers items for all goals of a user. In other examples, a separate component manages the feed items for each separate goal of the user. In this manner, a goal-specific component filters feed items and provides the visual augmentation and progress indicators for a single goal of the user.

The system in other examples provides a psychological factor associated with encouraging users to perform little tasks that move the user towards certain goals. With goals made concrete and measurable, it encourages increased data feed interaction.

In other examples, the system utilizes interaction data of the user and user feedback to improve filtering of goal-related items and generating progress indicators. The more users interact with the feed the more accurately the system can predict new actions, recommend goal-related items, and prioritize items in the feed. User feedback occurs when a user reports false positives or otherwise indicates an item is useful or an item was not useful for a specific goal.

Alternatively, or in addition to the other examples described herein, examples include any combination of the following:
calculate a per-item predicted completion metric value indicating a predicted completion contribution associated with user completion of the goal-related item;
generate a per-item progress indicator associated with the goal-related item within the personalized data feed representing the per-item predicted completion metric value;
wherein the per-item progress indicator provides a predicted level of additional user progress towards completion of the user goal achievable by user completion of the goal-related item;
generate a plurality of visual augmentations associated with a plurality of goal-related items from the plurality of items displayed within the personalized data feed;
calculate a per-item completion metric value for each goal-related item in the plurality of goal-related items;
generate a per-item progress indicator for each of the plurality of goal-related items within the personalized data feed;
wherein each per-item progress indicator provides a representation of the calculated per-item completion metric value for a corresponding goal-related item in the personalized data feed;
identify a set of goal-related items for each user-selected goal of a plurality of user-selected goals;
generate a unique goal-related progress indicator representing a current goal completion metric value calculated for each user-selected goal using the interaction data associated with the set of goal-related items for each user-selected goal;
the interaction data comprising a number of completed goal-related items of a plurality of goal-related items completed and a number of incomplete goal-related items in the plurality of goal-related items;
track user data feed interaction using the goal completion metric value and per-item predicted completion metric values associated with completed goal-related items and incomplete goal-related items;
identify a user-selected metric for quantifying goal completion progress;
calculate the goal completion metric and per-item predicted completion metrics using the user-selected metric;
wherein the user-selected metric comprises a percentage value representing completed goal-related items, a ratio of completed goal-related items to all goal-related items to obtain a current status percentage, and/or an estimated amount of time spent interacting with each goal-related item;
identify a new completed goal-related item in the plurality of goal-related items;
update the goal completion metric to reflect the new completed goal-related item;
update the goal-related progress indicator to reflect additional user progress towards completing the user goal;
update a machine learning component using the interaction data and user feedback associated with goal-related items for a given user-selected goal;
wherein the machine learning component improves selection of goal-related items from a plurality of items to assist the user in achieving the goal while increasing user interaction with items in the personalized data feed;
calculate a priority for each item in the personalized data feed;
prioritize placement of items within the personalized data feed in accordance with the calculated priority for each item; and
wherein the goal-related items have a higher priority than items in the personalized data feed which are unrelated to the user goal.

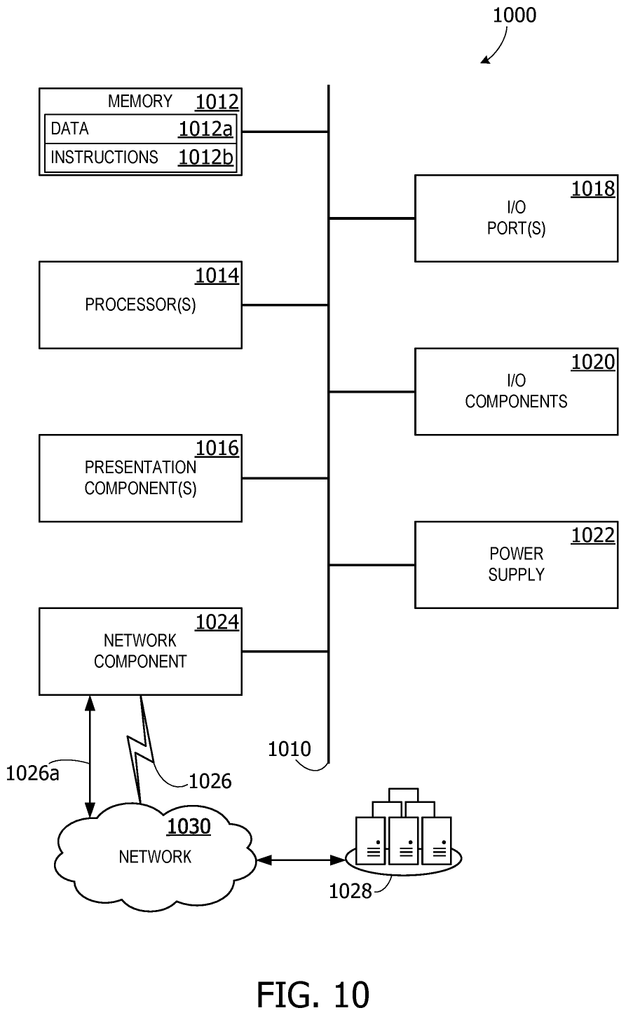

At least a portion of the functionality of the various elements in FIG. 1, FIG. 2 and FIG. 10 can be performed by other elements in FIG. 1, FIG. 2 and FIG. 10, or an entity (e.g., processor 106, web service, server, application program, computing device, etc.) not shown in FIG. 1, FIG. 2 and/or FIG. 10.

In some examples, the operations illustrated in FIG. 5, FIG. 6 and FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of providing an personalized data feed, the method comprising generating a visual augmentation associated with a goal-related item in a plurality of items within an personalized data feed presented to a user via a user interface device, the goal-related item is associated with a goal of the user; calculating a goal completion metric value indicating current overall progress of the user toward completing the goal using interaction data of the user, the interaction data comprising a number of completed goal-related items in a plurality of goal-related items completed and a number of incomplete goal-related items in the plurality of goal-related items; and generating a goal-related progress indicator within the personalized data feed, the goal-related progress indicator representing the calculated goal completion metric value indicating the current overall progress of the user toward completing the goal.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Example Operating Environment

FIG. 10 is a block diagram of an example computing device 1000 for implementing aspects disclosed herein and is designated as computing device 1000. The computing device 1000 is a computing device, such as the computing device 102 in FIG. 1. The computing device 1000 is an example of a suitable computing environment and is not intended to suggest any limitation as to the scope of use or functionality of the examples disclosed herein. Neither should the computing device 1000 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device.

Program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1000 includes a bus 1010 that directly or indirectly couples the following devices: computer-storage memory 1012, one or more processors 1014, one or more presentation components 1016, I/O ports 1018, I/O components 1020, a power supply 1022, and a network component 1024. While computing device 1000 is depicted as a single device, multiple computing devices 1000 may work together and share the depicted device resources. For example, memory 1012 may be distributed across multiple devices, and processor(s) 1014 may be housed with different devices.

Bus 1010 represents what may be one or more busses (such as an address bus, data bus, or a combination thereof). Although the various blocks of FIG. 10 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 10 and the references herein to a “computing device.”

Memory 1012 may take the form of the computer-storage media references below and operatively provide storage of computer-readable instructions, data structures, program modules and other data for computing device 1000. In some examples, memory 1012 stores one or more of an operating system, a universal application platform, or other program modules and program data. Memory 1012 is thus able to store and access data 1012a and instructions 1012b that are executable by processor 1014 and configured to carry out the various operations disclosed herein.

In some examples, memory 1012 includes computer-storage media in the form of volatile and/or nonvolatile memory, removable or non-removable memory, data disks in virtual environments, or a combination thereof. Memory 1012 may include any quantity of memory associated with or accessible by computing device 1000. Memory 1012 may be internal to computing device 1000 (as shown in FIG. 10), external to computing device 1000 (not shown), or both (not shown).

Examples of memory 1012 in include, without limitation, RAM; read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 1000. Additionally, or alternatively, memory 1012 may be distributed across multiple computing devices 1000, for example, in a virtualized environment in which instruction processing is carried out on multiple computing devices 1000. For the purposes of this disclosure, “computer storage media,” “computer storage device,” “computer-storage memory,” “memory,” and “memory devices” are synonymous terms for computer-storage memory 1012, and none of these terms include carrier waves or propagating signaling. In some examples, the memory 1012 is a memory such as, but not limited to, the memory 108 in FIG. 1.

Processor(s) 1014 may include any quantity of processing units that read data from various entities, such as memory 1012 or I/O components 1020 and may include CPUs and/or GPUs. Specifically, processor(s) 1014 are programmed to execute computer-executable instructions for implementing aspects of the disclosure. The instructions may be performed by the processor, by multiple processors within computing device 1000, or by a processor external to client computing device 1000. In some examples, processor(s) 1014 are programmed to execute instructions such as those illustrated in the in the accompanying drawings.

Moreover, in some examples, processor(s) 1014 represent an implementation of analog techniques to perform the operations described herein. For example, the operations may be performed by an analog client computing device 1000 and/or a digital client computing device 1000. In some examples, the processor(s) 1014 include one or more processors, such as but not limited to, the processor 106 in FIG. 1.

Presentation component(s) 1016 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1000, across a wired connection, or in other ways. I/O ports 1018 allow computing device 1000 to be logically coupled to other devices including I/O components 1020, some of which may be built in. Example I/O components 1020 include, for example but without limitation, a microphone, joystick, game pad, satellite dish, scanner, printer, wireless device, etc.

Computing device 1000 may operate in a networked environment via network component 1024 using logical connections to one or more remote computers. In some examples, network component 1024 includes a network interface card and/or computer-executable instructions (e.g., a driver) for operating the network interface card. Communication between computing device 1000 and other devices may occur using any protocol or mechanism over any wired or wireless connection.

In some examples, network component 1024 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1024 communicates over wireless communication link 1026 and/or a wired communication link 1026a to a cloud resource 1028 across network 1030. Various different examples of communication links 1026 and 1026a include a wireless connection, a wired connection, and/or a dedicated link, and in some examples, at least a portion is routed through the internet.

Although described in connection with an example computing device 1000, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Program modules include, but are not limited to, routines, programs, objects, components, and data structures that perform particular tasks or implement particular abstract data types.

Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se.

Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either”, “one of”, “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for providing a personalized data feed, the system comprising:
a processor; and
a memory comprising computer-readable instructions, the memory and the computer-readable instructions configured to cause the processor to:
generate a visual augmentation associated with a goal-related item of a plurality of items within the personalized data feed presented via a user interface, the goal-related item is associated with a user goal;
calculate a goal completion metric value indicating current overall progress of the user goal using interaction data of the user; and
generate a progress indicator within the personalized data feed, the progress indicator representing the calculated goal completion metric value indicating the current overall progress of the user goal.

2. The system of claim 1, wherein the memory and the computer-readable instructions are further configured to cause the processor to:
identify a user-selected metric for quantifying goal completion progress; and
calculate the goal completion metric and per-item predicted completion metrics using the user-selected metric, wherein the user-selected metric comprises a percentage value representing completed goal-related items, a ratio of completed goal-related items to all goal-related items, and an estimated amount of time spent interacting with each goal-related item.

3. The system of claim 1, wherein the memory and the computer-readable instructions are further configured to cause the processor to:
identify a set of goal-related items for each user-selected goal of a plurality of user-selected goals; and
generate a unique goal-related progress indicator representing a current goal completion metric value calculated for each user-selected goal using the interaction data associated with the set of goal-related items for each user-selected goal, the interaction data comprising a number of completed goal-related items of a plurality of goal-related items completed and a number of incomplete goal-related items in the plurality of goal-related items.

4. The system of claim 1, wherein the memory and the computer-readable instructions are further configured to cause the processor to:
calculate a per-item predicted completion metric value indicating a predicted completion contribution associated with user completion of the goal-related item; and
generate a per-item progress indicator associated with the goal-related item within the personalized data feed representing the per-item predicted completion metric value, wherein the per-item progress indicator provides a predicted level of additional user progress towards completion of the user goal achievable by user completion of the goal-related item.

5. The system of claim 1, wherein the memory and the computer-readable instructions are further configured to cause the processor to:
generate a plurality of visual augmentations associated with a plurality of goal-related items from the plurality of items displayed within the personalized data feed;
calculate a per-item completion metric value for each goal-related item in the plurality of goal-related items; and
generate a per-item progress indicator for each of the plurality of goal-related items within the personalized data feed, wherein each per-item progress indicator provides a representation of the calculated per-item completion metric value for a corresponding goal-related item in the personalized data feed.

6. The system of claim 1, wherein the memory and the computer-readable instructions are further configured to cause the processor to:
track user data feed interaction using the goal completion metric value and per-item predicted completion metric values associated with completed goal-related items and incomplete goal-related items.

7. The system of claim 1, wherein the memory and the computer-readable instructions are further configured to cause the processor to:
identify a new completed goal-related item in the plurality of goal-related items;
update the goal completion metric to reflect the new completed goal-related item; and
update the progress indicator to reflect additional user progress towards completing the user goal.

8. The system of claim 1, wherein the memory and the computer-readable instructions are further configured to cause the processor to:
update a machine learning component using the interaction data and user feedback associated with goal-related items for a given user-selected goal, wherein the machine learning component improves selection of goal-related items from a plurality of items to assist the user in achieving the goal while increasing user interaction with items in the personalized data feed.

9. The system of claim 1, wherein the memory and the computer-readable instructions are further configured to cause the processor to:
calculate a priority for each item in the personalized data feed; and
prioritize placement of items within the personalized data feed in accordance with the calculated priority for each item, wherein the goal-related items have a higher priority than items in the personalized data feed which are unrelated to the user goal.

10. A method for providing a personalized data feed, the method comprising:
generating a visual augmentation associated with a goal-related item of a plurality of items within the personalized data feed presented via a user interface, the goal-related item is associated with a user goal;
calculating a goal completion metric value indicating current overall progress of the user goal using interaction data of the user; and
generating a progress indicator within the personalized data feed, the progress indicator representing the calculated goal completion metric value indicating the current overall progress of the user goal.

11. The method of claim 10, further comprising:
identifying a user-selected metric for quantifying goal completion progress; and
calculating the goal completion metric and per-item predicted completion metrics using the user-selected metric, wherein the user-selected metric comprises at a percentage value representing completed goal-related items, a ratio of completed goal-related items to all goal-related items, and an estimated amount of time spent interacting with each goal-related item.

12. The method of claim 10, further comprising:
identifying a set of goal-related items for each user-selected goal of a plurality of user-selected goals; and
generating a unique goal-related progress indicator representing a current goal completion metric value calculated for each user-selected goal using the interaction data associated with the set of goal-related items for each user-selected goal, the interaction data comprising a number of completed goal-related items of a plurality of goal-related items completed and a number of incomplete goal-related items in the plurality of goal-related items.

13. The method of claim 10, further comprising:
calculating a per-item predicted completion metric value indicating a predicted completion contribution associated with user completion of the goal-related item; and
generating a per-item progress indicator associated with the goal-related item within the personalized data feed representing the per-item predicted completion metric value, wherein the per-item progress indicator provides a predicted level of additional user progress towards completion of the user goal achievable by user completion of the goal-related item.

14. The method of claim 10, further comprising:
generating a plurality of visual augmentations associated with a plurality of goal-related items within the plurality of items displayed within the personalized data feed;
calculating a per-item completion metric value for each goal-related item in the plurality of goal-related items; and
generating a plurality of per-item progress indicators within the personalized data feed, wherein each per-item progress indicator provides a representation of the calculated per-item completion metric value for a corresponding goal-related item in the personalized data feed.

15. The method of claim 10, further comprising:
tracking user data feed interaction using the goal completion metric value and per-item predicted completion metric values associated with completed goal-related items and incomplete goal-related items.

16. The method of claim 10, further comprising:
updating a machine learning component using the interaction data and user feedback associated with goal-related items for a given user-selected goal, wherein the machine learning component improves selection of goal-related items from a plurality of items to assist the user in achieving the goal while increasing user interaction with items in the personalized data feed.

17. The method of claim 10, further comprising:
assigning a priority to each item in the personalized data feed; and
prioritizing placement of items within the personalized data feed using the priority, wherein goal-related items are assigned a higher priority than items in the personalized data feed which are unrelated to the goal.

18. A computer readable storage device having computer-executable instructions for providing a personalized data feed that, upon execution by a processor, cause the processor to at least:
generate a visual augmentation associated with a goal-related item of a plurality of items within an interactive data feed presented via a user interface, the goal-related item is a user goal;
calculate a goal completion metric value indicating current overall progress of the user goal; and
generate a progress indicator within the interactive data feed, the progress indicator representing the calculated goal completion metric value indicating the current overall progress of the user goal.

19. The computer readable storage device of claim 18, wherein the processor further executes the computer-executable instructions to cause the processor to:
calculate a per-item predicted completion metric value indicating a predicted completion contribution associated with user completion of the goal-related item; and
generate a per-item progress indicator associated with the goal-related item within the interactive data feed representing the per-item predicted completion metric value, wherein the per-item progress indicator provides a predicted level of additional user progress towards completion of the user goal achievable by user completion of the goal-related item.

20. The computer readable storage device of claim 18, wherein the processor further executes the computer-executable instructions to cause the processor to:
generate a plurality of visual augmentations associated with a plurality of goal-related items within the plurality of items displayed within the interactive data feed;
calculate a per-item completion metric value for each goal-related item in the plurality of goal-related items; and
generate a plurality of per-item progress indicators within the interactive data feed, wherein a per-item progress indicator provides a representation of the per-item completion metric value for a corresponding goal-related item in the interactive data feed.
